(19) United States
(12) Patent Application Publication
(10) Pub. No.: US 2013/0049632 A1
(43) Pub. Date: Feb. 28, 2013

(54) LIGHT EMITTING DEVICE PACKAGE, LIGHTING DEVICE AND LIGHTING SYSTEM COMPRISNG THE SAME

(71) Applicant: Jun Hyoung KIM, Seoul (KR)

(72) Inventor: Jun Hyoung KIM, Seoul (KR)

(21) Appl. No.: 13/591,447

(22) Filed: Aug. 22, 2012

(30) Foreign Application Priority Data
Aug. 22, 2011 (KR) 10-2011-0083434

(51) Int. Cl. H05B 37/00

(52) U.S. Cl. 315/294

(57) ABSTRACT

A light emitting device package is provided that includes at least two light emitting device; and a lead unit electrically connected to the light emitting device, and supplying electric power from an outside to the light emitting device, wherein at least two light emitting devices among the light emitting devices are different in color coordinates from each other, and varied in color coordinates of emitted light color as a current flowing ratio of the light emitting devices having different color coordinates is varied depending on change in a level of current input to the lead unit.

### CROSS-REFERENCE TO RELATED APPLICATION

The present application claims priority under 35 U.S.C. §119(e) of Korean Patent Application No. 10-2011-0083434 filed Aug. 22, 2011 the subject matters of which are incorporated herein by reference.

### BACKGROUND

1. Field

Embodiments may relate to a light emitting device package, a lighting device and a lighting system having the same.

2. Background

A light emitting diode (LED) is an energy device for converting electric energy into light energy. Compared with an electric bulb, the LED has higher conversion efficiency, lower power consumption and a longer life span. As there advantages are widely known, more and more attentions are now paid to a lighting apparatus using the LED.

The lighting apparatus using the LED are generally classified into a direct lighting apparatus and an indirect lighting apparatus. The direct lighting apparatus emits light emitted from the LED without changing the path of the light. The indirect lighting apparatus emits light emitted from the LED by changing the path of the light through reflecting means and so on. Compared with the direct lighting apparatus, the indirect lighting apparatus mitigates to some degree the intensified light emitted from the LED and protects the eyes of users.

### SUMMARY

One embodiment is a lighting unit comprising: at least two light emitting device; and a lead unit electrically connected to the light emitting device, and supplying electric power from an outside to the light emitting device, wherein at least two light emitting devices among the light emitting devices are different in color coordinates from each other, and varied in color coordinates of emitted light color as a current flowing ratio of the light emitting devices having different color coordinates is varied depending on change in a level of current input to the lead unit.

Another embodiment is a lighting unit comprising: at least two light emitting device; and a lead unit electrically connected to the light emitting device, and supplying electric power from an outside to the light emitting device, wherein the light emitting device comprises a first light emitting device and a second light emitting device connected in parallel with the first light emitting device, and the level of current flowing in the second light emitting device is constant regardless of the level of current input to the lead unit, and the level of the current flowing in the first light emitting device is varied depending on variation in the level of current input to the lead unit.

Further another embodiment is a lighting unit comprising: first and second light emitting device groups comprising at least one light emitting device; a constant-current circuit group connected in parallel with the first light emitting device group, and comprising at least one constant-current circuit; and a lead unit electrically connected to the first and second light emitting device group and the constant-current circuit group, and supplying electric power from an outside to the first and second light emitting device group and the constant-current circuit group, wherein the constant-current circuits constituting the constant-current circuit groups are respectively connected to the second light emitting devices constituting the second light emitting device group, and each constant-current circuit controls the level of current flowing in the second slight emitting device connected to each constant-current circuit to be constant regardless of a level of current input to the lead unit, and the level of current flowing in at least one light emitting device among the light emitting devices constituting the first light emitting device group is varied depending on variation in the level of current input to the lead unit.

Further another embodiment is a lighting system comprising: an electric power terminal comprising a first end and a second to which electric power is applied; a current controller connected to the first end of the electric power terminal; and a lighting unit connected between the current controller and the second end of the electric power terminal, the lighting unit comprising: at least two light emitting device; and a lead unit electrically connected to the light emitting device, and supplying electric power from an outside to the light emitting device, wherein at least two light emitting devices among the light emitting devices are different in color coordinates from each other, and varied in color coordinates of emitted light color as a current flowing ratio of the light emitting devices having different color coordinates is varied depending on change in a level of current input to the lead unit, and wherein the current controller controls the level of current flowing in the lighting unit in accordance with an input value from an outside.

### BRIEF DESCRIPTION OF THE DRAWINGS

Arrangements and embodiments may be described in detail with reference to the following drawings in which like reference numerals refer to like elements and wherein:

FIG. 1 is an exploded perspective view showing a light emitting device package according to an embodiment;

FIG. 2 is a cross sectional view showing a first light emitting device and a second light emitting device of FIG. 1 respectively;

FIG. 3 is a circuit diagram showing a driving circuit according to an embodiment;

FIG. 4 is a two-dimensional (2D) graph showing spectrum distribution according to wavelengths with respect to two light sources different in color coordinates and mixture of two light sources;

FIG. 5 is a 2D color-coordinate graph showing color coordinates of a light emitting device package according to an embodiment;

FIG. 6 is a 2D color-coordinate graph showing an enlarged area taken along bold lines in FIG. 5;

FIG. 7 is a perspective view showing a lighting device including the light emitting device package according to an embodiment; and

FIG. 8 is a circuit diagram showing a lighting system including the light emitting device package according to an embodiment.

### DETAILED DESCRIPTION

A thickness or a size of each layer may be magnified, omitted or schematically shown for the purpose of convenience and clearness of description. The size of each component may not necessarily mean its actual size.

It should be understood that when an element is referred to as being ‘on’ or “under” another element, it may be directly on/under the element, and/or one or more intervening elements may also be present. When an element is referred to as being ‘on’ or ‘under’, ‘under the element’ as well as ‘on the element’ may be included based on the element.

An embodiment may be described in detail with reference to the accompanying drawings.

Elements of a light emitting device package

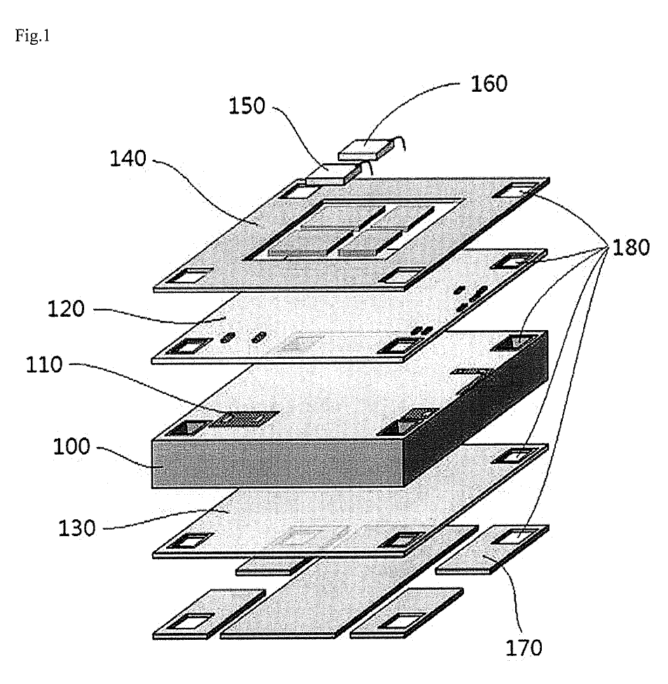

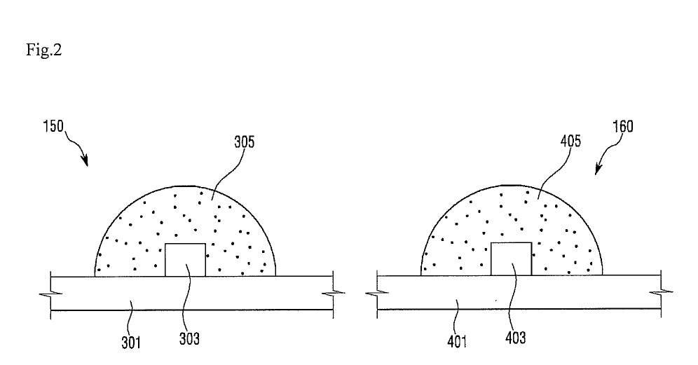

FIG. 1 is an exploded perspective view showing a light emitting device package varied in color temperature depending on applied current, according to an embodiment. FIG. 2 is a cross sectional view showing a first light emitting device and a second light emitting device of FIG. 1 respectively.

As shown in FIG. 1, the light emitting device package according to an embodiment includes a substrate 100, a driving circuit 110 mounted to the substrate 100, a first insulating layer 120 arranged on the substrate 100, a second insulating layer 130 arranged beneath the substrate 100, a metal layer 140 arranged on the first insulating layer 120, a first light emitting device 150 and a second light emitting device 160 arranged on the metal layer 140, a lead unit 170 arranged beneath the first insulating layer 120, and a via hole 180 penetrating the metal layer 140, the first insulating layer 120, the substrate 100, the second insulating layer 130 and the lead unit 170.

With the above configuration, the elements of the light emitting device package varied in color temperature according to applied current will be described below.

The substrate 100 serves as a body for the light emitting device package. The light emitting device package is classified into a plastic package, a ceramic package, a metal package, a silicon package, etc. according to materials used for the substrate 100. What material will be used for the substrate 100 may be determined by taking heat radiative effects, mass-productivity, costs, features of other elements, purpose • use of a product, and all conditions into consideration.

In the case of using silicon as a material for the substrate 100 of the light emitting device package 100, it may be stacked as multi-layers to manufacture the package and circuits may be mounted between the multi-layers. In the case of using the silicon substrate 100, there is an advantage that varieties are producible in quantity since it has a low degree of reflexibility dependence upon wavelengths of emitted light and can be manufactured in an integrated form of a wafer level.

In the substrate 100, the driving circuit 110 may be mounted for driving the first light emitting device 150 and the second light emitting device 160. The driving circuit 110 serves to drive the light emitting device to perform a desired function in accordance with the purpose • use of the light emitting device package. A method of configuring the driving circuit 110 according to an embodiment will be described below in detail.

On the substrate 100, the first insulating layer 120 may be arranged. The first insulating layer 120 serves to cut off electric connection between the substrate 100 and the metal layer 140. However, if the substrate 100 is made of a nonconductive material, the first insulating layer 120 may be omitted.

Beneath the substrate 100, the second insulating layer 130 may be arranged. The second insulating layer 130 serves to cut off electric connection between the substrate 100 and the lead unit 170. However, if the substrate 100 is made of a nonconductive material, the second insulating layer 130 may be omitted.

The metal layer 140 may be arranged on the first insulating layer 120, and the first light emitting device 150 and the second light emitting device 160 may be arranged on the metal layer 140. The metal layer 140 may be electrically connected to the first light emitting device 150 and the second light emitting device 160. Also, the metal layer 140 may be electrically connected to the driving circuit 110 for driving the first light emitting device 150 and the second light emitting device 160. That is, the metal layer 140 may serve as an electric lead wire for connecting the elements in the light emitting device package.

Also, the metal layer 140 may serve not only to radiate heat generated in the light emitting device package but also a supporter to support the first light emitting device 150 and the second light emitting device 160.

On the metal layer 140, the first light emitting device 150 and the second light emitting device 160 may be arranged. However, the light emitting device package according to an embodiment may include at least two light emitting devices. That is, the first light emitting device 150 and the second light emitting device 160 are just exemplified according to an embodiment, and the light emitting device may be additionally arranged in accordance with desired purposes and workshop modifications.

As a kind of solid-state device for converting electric energy into light, the first light emitting device 150 and the second light emitting device 160 generally include an active layer of a semiconductor material interposed between two contrary doping layers. When the two doping layers are biased, holes and electrons are injected into the active layer and recombined therein to generate light. The light generated in the active layer is radiated out of the light emitting device in all directions through all exposed surfaces.

At least two light emitting devices among the light emitting devices according to an embodiment may be different in color coordinate. Colors of light emitted from the respective light emitting device may be colors corresponding to arbitrary points on respective color coordinates.

Since use of a white light emitting device package has been increased as a light source of a lighting device, it will be described below on the assumption that the colors of light emitted from the first light emitting device 150 and the second light emitting device 160 according to an embodiment are colors corresponding to two different arbitrary points on a blackbody radiation curve.

One of the first light emitting device 150 and the second light emitting device 160 may have a color temperature of 6,000K to 8,000K. Also, the other one may have a color temperature of 2,300K to 4,000K. Below, it will be described on the assumption that the first light emitting device 150 is a cool white light emitting device having a color temperature of 6,000K to 8,000K and the second light emitting device 160 is a warm white light emitting device having a color temperature of 2,300K to 4,000K. Here, the peak wavelength of the second light emitting device 160 is different from that of the first light emitting device 150.

As shown in FIG. 2, to achieve the color temperature of the first light emitting device 150, the first light emitting device 150 includes a blue light emitting device 303, green and yellow fluorescent substances 305 on a substrate 301. To achieve the color temperature of the second light emitting device 160, the second light emitting device 160 includes a blue light emitting device 403, red and yellow fluorescent substances 405 on a substrate 401. Here, the first light emitting device 150 may include the blue light emitting device and the yellow fluorescent substance, and the second light emitting device 160 may include the blue light emitting device and the yellow fluorescent substance.

Here, the yellow fluorescent substance emits light having a dominant wavelength of from 540 nm to 585 nm in response to the blue light (430 nm to 480 nm). The green fluorescent substance emits light having a dominant wavelength of from 510 nm to 535 nm in response to the blue light (430 nm to 480 nm). The red fluorescent substance emits light having a dominant wavelength of from 600 nm to 650 nm in response to the blue light (430 nm to 480 nm).

That is, some of blue light emitted from the blue light emitting device excite a fluorescent substance, and thus the first light emitting device 150 and the second light emitting device 160 generate white light having the respective color temperatures as light from the fluorescent substance is mixed with the blue light emitted from the blue light emitting device. Meanwhile, though not shown, the first light emitting device 150 may generate the blue light, and the second light emitting device 160 may generate red light. Also, the first light emitting device 150 may generate the blue light with a short wavelength (400 nm to 470 nm), and the second light emitting device 160 may generate blue light with a long wavelength (470 nm to 500 nm). Also, the first light emitting device 150 may generate the blue light, and the second light emitting device 160 may generate green light.

Beneath the second insulating layer 130, the lead unit 170 may be arranged. The lead unit 170 may be made of a conductive material. The lead unit 170 may be electrically connected to the driving circuit 110 for driving the first light emitting device 150 and the second light emitting device 160. The lead unit 170 may be exposed to the outside of the light emitting device package and connected to an external circuit. Thus, the lead unit 170 may serve as an electric wire through which electric power is supplied from the outside to the light emitting device package.

Further, the via hole 180 may be formed to penetrating the metal layer 140, the first insulating layer 120, the substrate 100, the second insulating layer 130 and the lead unit 170. The via hole 180 may be formed by dry etching or wet etching. Alternatively, many other methods may be employed to form the via hole 180 as desired. The via hole 180 may be used as a passage where a wire is arranged to electrically connect different elements. That is, the wires for electric connection between the metal layer 140 and the driving circuit 110 and between the driving circuit 110 and the lead unit 170 may be arranged through the via hole 180.

The light emitting device package of FIG. 1 may be encapsulated by a molding unit (not shown). Materials constituting the molding unit may employ a transparent compound or resin for molding, epoxy, etc. Also, transfer molding or compression molding may cause a lens to be formed. The lens may serve to diffuse light emitted from the first light emitting device 150 and the second light emitting device 160. At this time, the lens may include a Fresnel lens, a cannonball type lens, etc. in addition to a semispherical lens. Also, the lens may be omitted.

Below, configurations of the driving circuit 110 for driving the first light emitting device 150 and the second light emitting device 160 according to an embodiment will be described in detail.

Configuration of the Driving Circuit 110

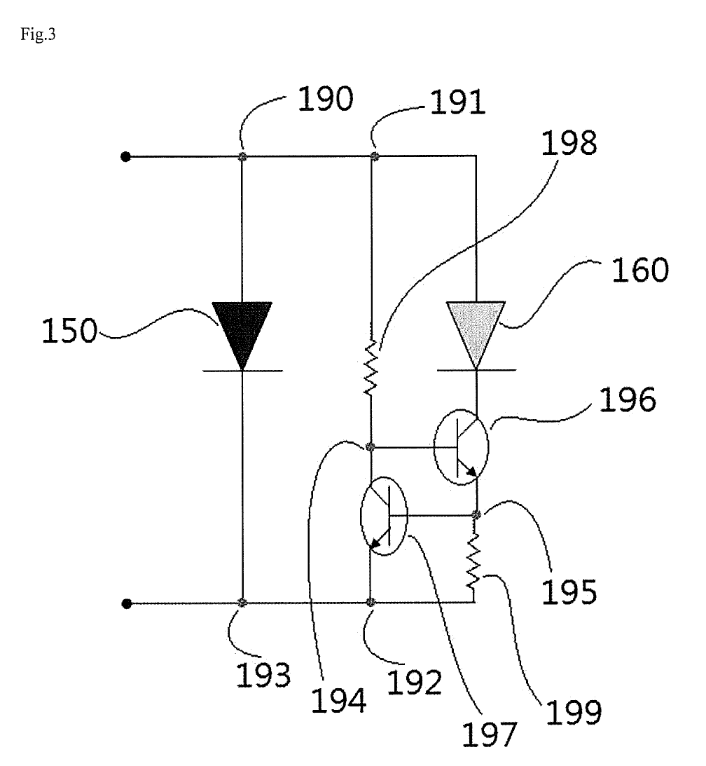

FIG. 3 is a circuit diagram showing the driving circuit 110 for driving the first light emitting device 150 and the second light emitting device 160 according to an embodiment;

Referring to FIG. 3, the first light emitting device 150 and the second light emitting device 160 may be connected in parallel. An anode of the first light emitting device 150 may be connected to a first node 190, and a cathode of the first light emitting device 150 may be connected to a fourth node 193. An anode of the second light emitting device 160 may be connected to a second node 191, and a cathode of the second light emitting device 160 may be connected to a collector of a first transistor 196.

An emitter of the first transistor 196 may be connected to a sixth node 195. the second resistor 199 may be connected between the sixth node 195 and a third node 192. The first resistor 198 may be connected between a second node 191 and a fifth node 194. A base of the first transistor 196 may be connected to the fifth node 194. A collector of the second transistor 197 may be connected to the fifth node 194. A base of the second transistor 197 may be connected to the sixth node 195. An emitter of the second transistor 197 may be connected to a third node 192.

A circuit including the first resistor 198, the second resistor 199, the first transistor 196 and the second transistor 197 between the second node 191 and the third node 192 is a constant-current circuit. Thus, the constant-current circuit may cause current having a constant level to flow between the second node 191 and the third node 192 regardless of the intensity of current input to the whole circuit.

If a voltage drop higher than a potential barrier of the second transistor 197 occurs in a second resistor 199, the second transistor 197 operates. Thus, if collector current of the second transistor 197 increases, a voltage drop occurs in the first resistor 198. If the voltage drop occurs in the first resistor 198, base current of the first transistor 196 decreases. If the base current of the first transistor 196 decreases, collector current of the first transistor 196 is decreased. Thus, if emitter current of the first transistor 196 decreases, a voltage drop generated in the second resistor 199 is decreased. If the voltage drop generated in the second resistor 199 is decreased to be lower than the potential barrier of the second transistor 197, the second transistor 197 does not operate. If the second transistor 197 does not operate, the base current of the first transistor 196 increases. If the base current of the first transistor 196 increases, the collector current of the first transistor 196 increases. Thus, if the emitter current of the first transistor 196 increases, the voltage drop generated in the second resistor 199 is increased. If the voltage drop generated in the second resistor 199 is higher than the potential barrier of the second transistor 197, the second transistor 197 operates.

The foregoing processes are continuously repeated to make the level of the current flowing between the second node 191 and the third node 192 be stably constant.

The current input to the whole circuit may be divided and flow into the first light emitting device 150 and the second light emitting device 160. As above, the current with constant level may flow in the second light emitting device 160 regardless of the level of current input to the whole circuit. Therefore, current, which remains by subtracting the current with a constant level flowing in the second light emitting device 160 from the current input to the whole circuit, may flow in the first light emitting device 150 regardless of the level of current input to the whole circuit.

For example, it will be described on the assumption that current of 50 mA is set to flow in the second light emitting device 160 regardless of the level of current input to the whole circuit.

First, suppose that current of 500 mA is input to the whole circuit. In this case, current of 450 mA may flow in the first light emitting device 150, and current of 50 mA may flow in the second light emitting device 160. That is, the current flowing in the first light emitting device 150 and the second light emitting device 160 has a ratio of 9:1.

Second, suppose that current of 200 mA is input to the whole circuit. In this case, current of 150 mA may flow in the first light emitting device 150, and current of 50 mA may flow in the second light emitting device 160. That is, the current flowing in the first light emitting device 150 and the second light emitting device 160 has a ratio of 3:1.

In FIG. 3, the first transistor 196 and the second transistor 197 may be an npn-type transistor, but not limited thereto. According to an embodiment, a pnp-type transistor may be used. In the case of using the pnp-type transistor, a connecting direction of the first light emitting device 150 and the second light emitting device 160 may be reversed.

Meanwhile, the circuit diagram shown in FIG. 3 is nothing but an example of the driving circuit 110 for controlling the current flowing in the first light emitting device 150 and the second light emitting device 160. Alternatively, various circuits may be possible.

Below, functional effects of the driving circuit 110 with the foregoing configuration will be described in detail.

Variation in color coordinates depending on operation of the driving circuit 110

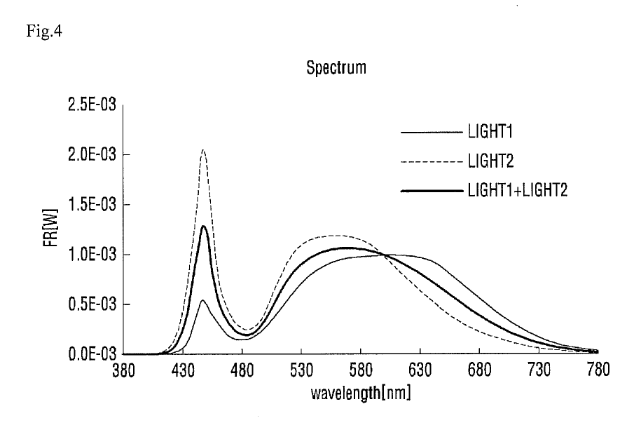

FIG. 4 is a 2D graph showing spectrum distribution according to wavelengths with respect to two light sources different in color coordinates and mixture of two light sources.

FIG. 4 illustrates spectrum distribution according to wavelengths measured with regard to two arbitrary light sources LIGHT1, LIGHT2 different in color coordinates. Also, FIG. 3 illustrates spectrum distribution according to wavelengths measured with regard to mixture (LIGHT1+LIGHT2) of the two light sources LIGHT1, LIGHT2 having the same intensity of light.

Assume that there are at least two light sources and at least two light sources among them are different in color coordinates. If the light sources are arranged to be adjacent to one another and they are seen at a sufficient long distance, it looks as if colors of the light sources are mixed. If the light sources are arranged more closely to one another, it looks as if the colors are better mixed.

At this time, the intensity of light of the mixed light sources is the sum of respective intensities of the light sources. Also, the mixed color is approximate to the color of each light source in proportion to the intensity of each light source. Therefore, the color coordinates of the mixed color correspond to one point within a polygon formed by regarding the color coordinates of the respective light sources as vertexes on the graph where the color coordinates are expressed in a two-dimension. Also, if two light sources LIGHT1, LIGHT2 having the same intensity of light are mixed (LIGHT1+LIGHT2), the mixed color has a middle value between the colors of the two light sources (LIGHT1, LIGHT2) and thus results in spectrum distribution as shown in FIG. 4.

Below, an example where the first light emitting device 150 and the second light emitting device 160 according to an embodiment are used as the light sources for the light emitting device package will be described in more detail.

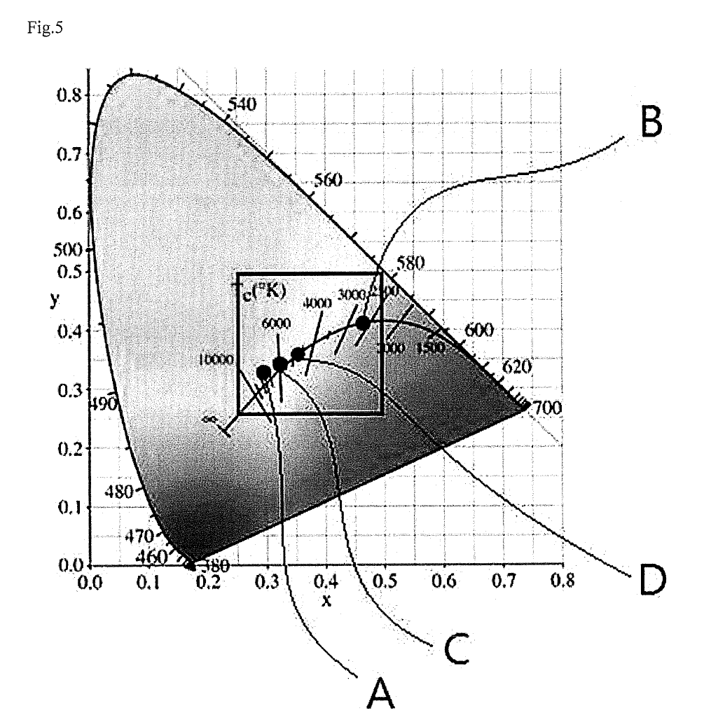

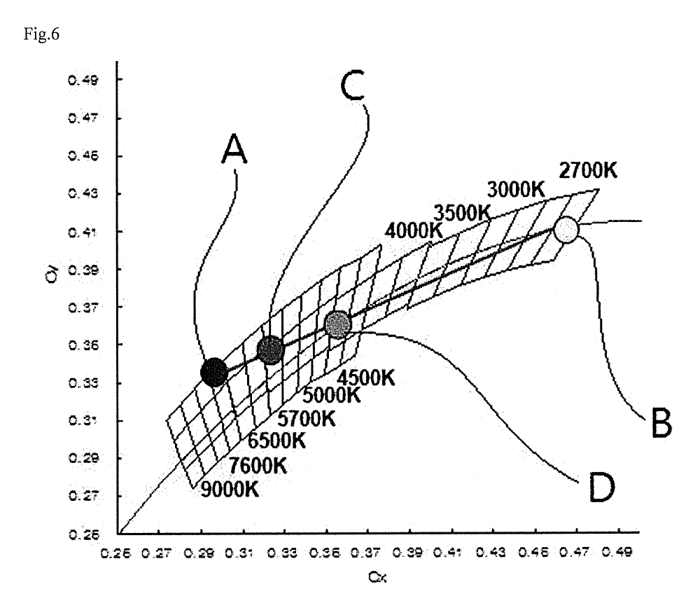

FIG. 5 is a 2D color-coordinate graph showing color coordinates of a light emitting device package according to an embodiment, and FIG. 6 is a 2D color-coordinate graph showing an enlarged area taken along bold lines in FIG. 5. Referring to FIGS. 5 and 6, the color coordinates of the first light emitting device 150 and the second light emitting device 160 are denoted with A and B, respectively.

First, assume that current of 500 mA is input to the light emitting device package. Also, suppose that current of 50 mA is set to flow in the second light emitting device 160 regardless of the level of current input to the light emitting device package according to an embodiment. In this case, current of 450 mA may flow in the first light emitting device 150, and current of 50 mA may flow in the second light emitting device 160. That is, the current flowing in the first light emitting device 150 and the second light emitting device 160 has a ratio of 9:1.

In general, the intensity of light emitted from the light emitting device may be proportional to the level of current flowing in the light emitting device. Therefore, the intensity of light emitted from the first light emitting device 150 and the second light emitting device 160 has a ratio of 9:1.

The light emitted from the light emitting device package according to an embodiment has color corresponding to the mixture of color of the first light emitting device 150 and the second light emitting device 160. At this time, the color coordinates of the mixed color may correspond to one point on a line connecting A and B in FIG. 6. As described above, since it is assumed that the first light emitting device 150 is the cool white light emitting device having a color temperature of 6,000K to 8,000K, and the second light emitting device 160 is the warm white light emitting device having a color temperature of 2,300K to 4,000K, the color temperature of the light emitted from the light emitting device package according to an embodiment may range from 2,300K to 8,000K.

Also, the mixed color is approximate to the color of the first light emitting device 150 and the second light emitting device 160 in proportion to the intensity of light from the first light emitting device 150 and the second light emitting device 160. Therefore, the color coordinates of the light emitted from the light emitting device package according to an embodiment may correspond to a point of C. At this time, a ratio of length between A and C and length between C and B may be 1:9.

Second, assume that current of 200 mA is input to the light emitting device package. Also, suppose that current of 50 mA is set to flow in the second light emitting device 160 regardless of the level of current input to the light emitting device package according to an embodiment. In this case, current of 150 mA may flow in the first light emitting device 150, and current of 50 mA may flow in the second light emitting device 160. That is, the current flowing in the first light emitting device 150 and the second light emitting device 160 has a ratio of 3:1.

In general, the intensity of light emitted from the light emitting device may be proportional to the level of current flowing in the light emitting device. Therefore, the intensity of light emitted from the first light emitting device 150 and the second light emitting device 160 has a ratio of 3:1. The light emitted from the light emitting device package according to an embodiment has color corresponding to the mixture of color of the first light emitting device 150 and the second light emitting device 160. At this time, the color coordinates of the mixed color may correspond to one point on a line connecting A and B in FIG. 6. Also, the mixed color is approximate to the color of the first light emitting device 150 and the second light emitting device 160 in proportion to the intensity of light from the first light emitting device 150 and the second light emitting device 160. Therefore, the color coordinates of the light emitted from the light emitting device package according to an embodiment may correspond to a point of D. At this time, a ratio of length between A and D and length between D and B may be 1:3.

That is, if the current input to the light emitting device package according to an embodiment is changed from 500 mA into 200 mA, the color coordinates of the light emitted from the light emitting device package may be changed from C to D. In other words, if the level of current input to the light emitting device package according to an embodiment decreases, the color temperature of the light emitted from the light emitting device package may be lowered. On the other hand, if the level of current input to the light emitting device package according to an embodiment increases, the color temperature of the light emitted from the light emitting device package may become higher.

Generally, the intensity of light emitted from the light emitting device used as the light source may be proportional to the level of current flowing in the light emitting device, and the intensity of light from the mixed light sources may be the sum of intensities of light from the respective light sources. Therefore, the intensity of light emitted from the light emitting device package according to an embodiment may be proportional to the level of current input to the light emitting device package. Accordingly, if the level of current input to the light emitting device package according to an embodiment decreases, the color temperature of light emitted from the light emitting device package may become lowered, and at the same time the intensity of light may be decreased. On the other hand, if the level of current input to the light emitting device package according to an embodiment increases, the color temperature of light emitted from the light emitting device package may become higher, and at the same time the intensity of light may be increased.

In the case of emotional lighting, the lighting device having a cool white color temperature may be generally used in study, business or work requiring rational thinking ability. Also, the lighting device having a warm white color temperature may be generally used in rest, listening to music or work requiring emotional thinking ability. Typically, high intensity of light may be good to study, business or the like, and the low intensity of light may be good to rest, listening to music, or the like.

If the level of current input to the light emitting device package according to an embodiment increases, it may be approximate to the cool white color temperature and have high intensity of light. On the other hand, if the level of current input to the light emitting device package according to an embodiment decreases, it may be approximate to the warm white color temperature and have low intensity of light. Thus, the light emitting device package according to an embodiment can control both the color temperature and the intensity of the emitted light by just adjusting the level of the input current, so that it can be used as the light source for interior lighting, particularly the emotional lighting. Also, the light emitting device package according to an embodiment may simplify the driving circuit for driving the emotional lighting.

Like the light emitting device package according to an embodiment, to increase both the color temperature and the intensity of the light emitted from the light emitting device package as the level of the input current increases, the light emitting device having the lowest color temperature among at least two light emitting devices arranged in the light emitting device package may be connected to the constant-current circuit like the operation in the driving circuit 110. That is, if the level of the input current increases, the level of current flowing in the light emitting devices having a relatively higher color temperature has to become higher, so that current with a constant level can flow in the light emitting device having the lowest color temperature among the light emitting devices regardless of the level of the current input to the light emitting device package.

With recent attention paid to the emotional lighting, there has been used a method where a plurality of warm white light emitting device packages and a plurality of cool white light emitting device packages are arranged to be adjacent to each other, and the intensity of light thereof or a ratio of the number of them is controlled to thereby control the whole color temperature. However, if the plurality of warm white light emitting device packages and the plurality of cool white light emitting device packages used as the light sources are arranged to be adjacent to each other, a problem arises in that a color band (color strap) may be generated due to intervals at which the light sources are arranged.

If the light sources are arranged more closely to one another, it looks as if the colors are better mixed. Accordingly, in order to solve the above problem, one light emitting device package according to an embodiment includes the first light emitting device 150 having a cool white color temperature and the second light emitting device 160 having a warm white color temperature. Also, one light emitting device package according to an embodiment includes the driving circuit 110 for controlling the current flowing in the first light emitting device 150 and the second light emitting device 160, so that a ratio of current flowing in the first light emitting device 150 and the second light emitting device 160 can be varied depending on the level of current applied to the light emitting device package. Thus, the color temperature of the light emitted from the light emitting device package may be controlled within a range between the color temperature of the first light emitting device 150 and the color temperature of the second light emitting device 160. Further, it is possible to control the intensity of the light while controlling the color temperature of the light emitted from the light emitting device package.

A Lighting Device

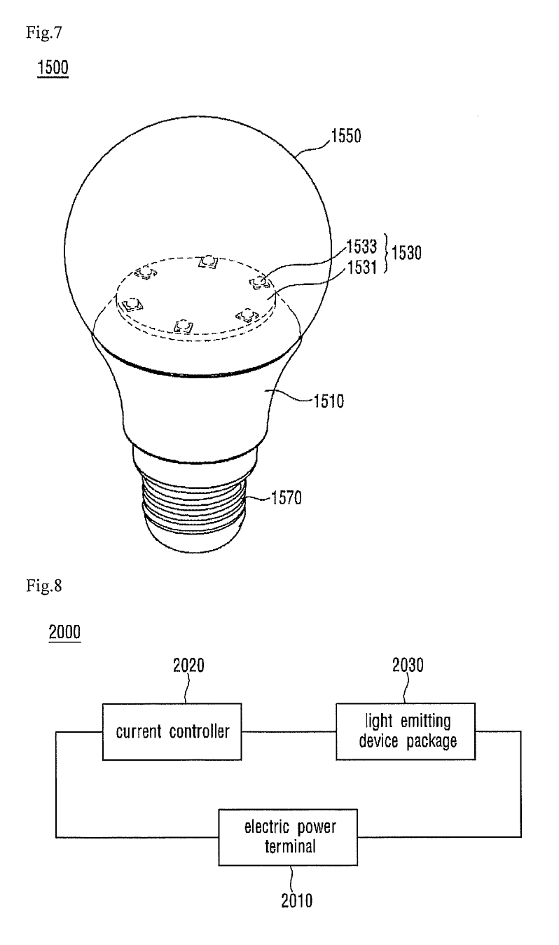

FIG. 7 is a perspective view showing a lighting device including the light emitting device package according to an embodiment.

Referring to FIG. 7, the lighting device 1500 includes a case 1510, a light emitting module 1530 arranged on the case 1510, a cover 1550 connected to the case 1510, and a connection terminal 1570 connected to the case 1510 and receiving electric power form an external power source.

The case 1510 may be made of a material having a good heat-radiant characteristic such as metal and resins.

The light emitting module 1530 may include a board 1531 and at least one light emitting device package 1533 according to an embodiment mounted to the board 1531. The plurality of light emitting device packages 1533 may be radially arranged to be spaced apart from each other at predetermined distance.

The board 1531 may be an insulating substrate printed with a circuit pattern and may for example include a printed circuit board (PCB), a metal core PCB, a flexible PCB, a ceramic PCB, an FR-4 substrate, or the like.

Also, the board 1531 may be made of a material capable of effectively reflecting light, and may have a surface with color of white or silver having an effect on reflecting light.

At least one light emitting device package 1533 may be arranged on the board 1531. Each of the light emitting device packages 1533 may include at least one light emitting diode (LED) chip. The LED chip may include a red, green, blue or white LED and an ultraviolet (UV) LED for emitting UV light.

The light emitting module 1530 may have various combinations of the light emitting device packages 1533 to get desired color and brightness. For instance, the light emitting module 1530 may have combination of white, red and green LEDs to get a high color rendering index (CRI).

The connection terminal 1570 may be electrically connected for power supply to the light emitting module 1530. The connection terminal 1570 may be provided in the form of a socket and screw-coupled to the external power, but not limited thereto. Alternatively, the connection terminal 1570 may be provided in the form of a pin and inserted in the external power, or may be connected to the external power through an electric wire.

A Lighting System

FIG. 8 is a circuit diagram showing a lighting system 2000 including the light emitting device package 2030 according to an embodiment.

Referring to FIG. 8, the lighting system 2000 includes an electric power terminal 2010 having first and second ends to which power is applied, a current controller 2020 connected to the first end of the electric power terminal 2010, and a light emitting device package 2030 connected between the current controller 2020 and the second end of the electric power terminal 2010.

The current controller 2020 may control a level of current flowing in the light emitting device package in accordance with an input value from the outside. The input value from the outside may be input by a user of the lighting system 2000, or may be input from another external circuit. Also, the input value may be statically preset, or dynamically varied. The current controller 2020 may receive such an input value and control a current level input to the lead unit of the light emitting device package 2030.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lighting unit comprising:
at least two light emitting device; and
a lead unit electrically connected to the light emitting device, and supplying electric power from an outside to the light emitting device,
wherein at least two light emitting devices among the light emitting devices are different in color coordinates from each other, and varied in color coordinates of emitted light color as a current flowing ratio of the light emitting devices having different color coordinates is varied depending on change in a level of current input to the lead unit.

2. The lighting unit according to claim 1, wherein the at least two light emitting devices different in color coordinates from each other comprise a first light emitting device and a second light emitting device connected in parallel with the first light emitting device and having different color coordinates from the first light emitting device, and
the level of current flowing in the second light emitting device is constant regardless of the level of current input to the lead unit, and the level of the current flowing in the first light emitting device is varied depending on variation in the level of current input to the lead unit.

3. The lighting unit according to claim 2, wherein the first light emitting device comprises a group consisting of a blue light emitting device and at least one of yellow and green fluorescent substance, and wherein the second light emitting device has a peak wavelength different from that of the first light emitting device, and comprises a group consisting of a blue light emitting device and at least one of red and green fluorescent substance.

4. The lighting unit according to claim 2, wherein the first light emitting device comprises a group consisting of a blue light emitting device and at least one of yellow and green fluorescent substances, and wherein the second light emitting device comprises a group consisting of a red light emitting device and at least one of yellow and green fluorescent substance.

5. The lighting unit according to claim 2, further comprising a constant-current circuit electrically connected to the light emitting device and the lead unit,
the constant-current circuit being connected to the second slight emitting device, and controlling the level of current flowing in the second light emitting device to be constant regardless of the level of current input to the lead unit.

6. The lighting unit according to claim 5, wherein the constant-current circuit comprises a first transistor, a second transistor, a first resistor, a second resistor, a first node and a second node, and
the first node and the second node are connected to an external circuit, the first node is connected to an anode of the second light emitting device, a cathode of the second light emitting device is connected to a first terminal of the first transistor, a second terminal of the first transistor is connected to a first end of the second resistor, a second end of the second resistor is connected to the second node, the second node is connected to a second terminal of the second transistor, a third terminal of the second transistor is connected to the first end of the second resistor, the first terminal of the second transistor is connected to a third terminal of the first transistor, the first terminal of the second transistor is connected to a first end of the first resistor, and a second end of the first resistor is connected to the first node.

7. The lighting unit according to claim 1, wherein the color temperature of the emitted light color is varied in a range between 2,300K and 8,000K depending on the level of current input to the lead unit.

8. The lighting unit according to claim 1, wherein the color temperature of the emitted light color becomes higher and intensity of emitted light increases if the level of current input to the lead unit increases.

9. The lighting unit according to claim 2, wherein the second light emitting device comprises a light emitting device having the lowest color temperature among the at least two light emitting devices.

10. The lighting unit according to claim 2, wherein the first light emitting device has one 6,000K and 8,000K, and the second light emitting device has one color temperature between 2,300K and 4,000K.

11. A lighting unit comprising:
at least two light emitting device; and
a lead unit electrically connected to the light emitting device, and supplying electric power from an outside to the light emitting device,
wherein the light emitting device comprises a first light emitting device and a second light emitting device connected in parallel with the first light emitting device, and
the level of current flowing in the second light emitting device is constant regardless of the level of current input to the lead unit, and the level of the current flowing in the first light emitting device is varied depending on variation in the level of current input to the lead unit.

12. The lighting unit according to claim 11, further comprising a constant-current circuit electrically connected to the light emitting device and the lead unit,
the constant-current circuit being connected to the second slight emitting device, and controlling the level of current flowing in the second light emitting device to be constant regardless of the level of current input to the lead unit.

13. The lighting unit according to claim 12, wherein the constant-current circuit comprises a first transistor, a second transistor, a first resistor, a second resistor, a first node and a second node, and
the first node and the second node are connected to an external circuit, the first node is connected to an anode of the second light emitting device, a cathode of the second light emitting device is connected to a first terminal of the first transistor, a second terminal of the first transistor is connected to a first end of the second resistor, a second end of the second resistor is connected to the second node, the second node is connected to a second terminal of the second transistor, a third terminal of the second transistor is connected to the first end of the second resistor, the first terminal of the second transistor is connected to a third terminal of the first transistor, the first terminal of the second transistor is connected to a first end of the first resistor, and a second end of the first resistor is connected to the first node.

14. A lighting unit comprising:
first and second light emitting device groups each comprising at least one light emitting device;
a constant-current circuit group connected in parallel with the first light emitting device group, and comprising at least one constant-current circuit; and
a lead unit electrically connected to the first and second light emitting device group and the constant-current circuit group, and supplying electric power from an outside to the first and second light emitting device group and the constant-current circuit group,
wherein the constant-current circuits constituting the constant-current circuit groups are respectively connected to the second light emitting devices constituting the second light emitting device group, and
each constant-current circuit controls the level of current flowing in the second slight emitting device connected to each constant-current circuit to be constant regardless of a level of current input to the lead unit, and the level of current flowing in at least one light emitting device among the light emitting devices constituting the first light emitting device group is varied depending on variation in the level of current input to the lead unit.

15. The lighting unit according to claim 14, wherein each constant-current circuit comprises a first transistor, a second transistor, a first resistor, a second resistor, a first node and a second node, and
the first node and the second node are connected to an external circuit, the first node is connected to an anode of the second light emitting device, a cathode of the second light emitting device is connected to a first terminal of the first transistor, a second terminal of the first transistor is connected to a first end of the second resistor, a second end of the second resistor is connected to the second node, the second node is connected to a second terminal of the second transistor, a third terminal of the second transistor is connected to the first end of the second resistor, the first terminal of the second transistor is connected to a third terminal of the first transistor, the first terminal of the second transistor is connected to a first end of the first resistor, and a second end of the first resistor is connected to the first node.

16. A lighting system comprising:
an electric power terminal comprising a first end and a second to which electric power is applied;
a current controller connected to the first end of the electric power terminal; and
a lighting unit connected between the current controller and the second end of the electric power terminal,
the lighting unit comprising:
at least two light emitting device; and
a lead unit electrically connected to the light emitting device, and supplying electric power from an outside to the light emitting device,
wherein at least two light emitting devices among the light emitting devices are different in color coordinates from each other, and varied in color coordinates of emitted light color as a current flowing ratio of the light emitting devices having different color coordinates is varied depending on change in a level of current input to the lead unit, and
wherein the current controller controls the level of current flowing in the lighting unit in accordance with an input value from an outside.

17. The lighting system according to claim 16, wherein the at least two light emitting devices different in color coordinates from each other comprise a first light emitting device and a second light emitting device connected in parallel with the first light emitting device and having different color coordinates from the first light emitting device, and
the level of current flowing in the second light emitting device is constant regardless of the level of current input to the lead unit, and the level of the current flowing in the first light emitting device is varied depending on variation in the level of current input to the lead unit.

18. The lighting system according to claim 16, further comprising a constant-current circuit electrically connected to the light emitting device and the lead unit,
the constant-current circuit being connected to the second slight emitting device, and controlling the level of current flowing in the second light emitting device to be constant regardless of the level of current input to the lead unit.
